(19) United States
(12) Patent Application Publication
(10) Pub. No.: US 2021/0382484 A1
(43) Pub. Date: Dec. 9, 2021

(54) METHOD FOR CONTROLLING A TOWING TRAIN

(71) Applicant: SCHOTTEL GMBH, SPAY/RHEIN (DE)

(72) Inventor: Gerhard Jensen, Beulich (DE)

(73) Assignee: SCHOTTEL GMBH, SPAY/RHEIN (DE)

(21) Appl. No.: 17/046,680

(22) PCT Filed: Apr. 24, 2019
(86) PCT No.: PCT/EP2019/060514

§ 371 Date: Oct. 9, 2020

(30) Foreign Application Priority Data
Apr. 25, 2018 (DE) 10 2018 109 917.7

(51) Int. Cl. G05D 1/02; B63B 21/56; B63B 35/68; B63B 21/20; B63B 79/40; B63B 79/20; B63B 79/15

(52) U.S. Cl. CPC G05D 1/0206; B63B 21/56; B63B 35/68; B63B 79/15; B63B 79/40; B63B 79/20; B63B 21/20

(57) ABSTRACT

A method for controlling a towing train including a ship and at least one tug acting on the ship, including the steps of: providing a data model, which includes fixed data of the ship and of the at least one tug as well as variable environmental data; determining the current course, the thrust vector, and the inertial force of the ship and specifying a desired travel direction of the ship with subsequent calculation of the correction force vector and correction torque required to achieve the desired travel direction; calculating the required positions, orientations, and drive settings of the at least one acting tug using an algorithm that accesses the data model and generating control commands for the at least one tug such that the sum of all the force vectors and torques of the at least one acting tug corresponds to the required correction force vector and correction torque; transmitting the generated control commands to at least one acting tug and monitoring the completion of the control commands; and conducting an evaluation of the produced correction force vector and correction torque after completion of the control commands and generating and storing correction values in the data model when deviations are detected between the produced correction force vector and the required correction force vector and/or between the produced correction torque and the required correction torque and then repeating certain steps.

### BACKGROUND OF THE INVENTION

### Field of the Invention

This invention relates to a method for controlling a towing train including a ship and at least one tug acting on the ship.

### Discussion of Related Art

Towing trains of this kind are customary, for example in maritime navigation, in order to bring ships, which have only limited maneuverability in a harbor due to their size, to their designated berth or to bring them from this berth out of the harbor and also in order to rescue disabled ships and/or bring them in to harbor.

The tugs used for this are usually highly maneuverable boats with powerful propulsion systems, which are used for towing, pushing, and slowing ships that are in most cases comparatively much larger. The force is transmitted to the ship by pulling on tow lines, which are known as hawsers, or by direct pushing with the bow or stern against the ship's hull.

Depending on the application, the tugs of a towing train provide assistance in mooring and disembarkation maneuvers of large ships, like assistance, assistance of ships during travel through narrow passages such as harbor entrances and canals for escort, or rescue stricken ships for salvage.

In accordance with these applications, the tugs used must meet high demands with regard to maneuverability, thrust generation, and production of powerful steering and braking forces. In general, tugs are propelled by azimuthing systems, which are able to direct the thrust in any desired direction over 360° relative to the vertical axis. Such tugs are equipped either with Voith-Schneider vertical axis rotors (VSP) or azimuth rudder propellers in the form of fixed propellers (FPP) or adjustable propellers (CPP) with jets. Frequently used tug types are tractor tugs and ASD tugs or azimuth stern drive. In tractor tugs, the propulsion systems, usually two systems, are installed in the bow region and in ASD tugs, they are installed are installed in the stern of the vessel. The distinctive feature here is the installation and positioning of the propulsion units at the bow or stern. Other known tug types are rotor tugs with two propulsion systems under the prow and another at the stern, GIANO tugs with a respective propulsion system in the bow and in the stern and the like.

The different types of tugs also differ substantially in the hull shapes and the shape of the skeg, which are used for stabilizing and for enlarging the underwater lateral area in order to generate greater transverse resistance forces, which in addition to the generated thrust make up a significant part of the forces exerted on the ship in the towing train.

Depending on the required maneuver for the ship that is to be moved, an individual tug can assume various positions and orientations relative to it in order to exert a desired force. In the train including a plurality of tugs, the exerted forces and moments add up to a resulting total force and a resulting total moment.

The possible positions of the tugs are limited by the position of the attachment of the individual tow lines to the ship, their length, their attachment points on the ship's hull, and by the avoidance of dangerous operating states. Up to now, determining the best position and orientation of the tug in order to produce the greatest possible effect has been up to the experience of the captain of the tug. If multiple tugs are involved in the maneuvering task, this also requires a coordination of the individual tugs with one another, usually by consultation among the individual captains of the tugs and/or at the instruction of a pilot located on the ship. This requires a large amount of experience.

It is known to use calculation programs to determine the escorting capacity and force action of tugs, for example, in order to verify the design of the tug or to furnish proof of a sufficient force production, which is expressed in the form of what is referred to as an escort notation.

Depending on the design and size of the respective tug, the interplay of the forces and moments occurring are influenced by different parameters such as the thrust generation of the propulsion systems due to variations in performance, the direction of the tension, the steering angle of the individual propulsion systems and their positioning, as well as flow forces due to the orientation of the tug relative to the travel direction and speed of the ship.

Up to now, these different parameters have prevented data of a specific tug, which have been determined in model experiments, from being adopted into an assistance system that executes or assists the positioning and drive of the individual tugs of a towing train independently of their design and the size of the towing train in order to make optimal use of the individual tugs, for example, to use the lowest possible thrust application in order to increase efficiency.

Furthermore, PCT Publication WO 2018/004353 A1 discloses a dynamic control for the towing line winches provided on the tugs, which positions a tug in a suitable working region for the use of the winch. The known control, however, is not able to choose the optimal positioning of the individual tugs of a towing train.

### SUMMARY OF THE INVENTION

One object of this invention is to provide a method for controlling a towing train including a ship of at least one tug acting on the ship, which method, as an automated assistance system, automatically determines the most efficient position and drive configuration of the individual tugs for a specific towing task and transmits them to the involved tugs so that they can then be correspondingly positioned and configured by their respective captains or be placed into the calculated positions and drive configurations in an automated fashion.

In order to attain the above and other objects, this invention provides one embodiment of a method according to the features described in this specification and in the claims.

Advantageous embodiments and modifications of the method according to this invention are the subject of the dependent claims.

In order to control the towing train including a ship and at least one tug acting on the ship, this invention provides executing the following sequence of steps, for example in an automated fashion in a corresponding data processing system:

a) providing a data model, which includes fixed data of the ship and of the at least one tug as well as variable environmental data;

b) determining the current course, the thrust vector, and the inertial force of the ship and specifying a desired travel direction of the ship with subsequent calculation of the correction force vector and correction torque required to achieve the desired travel direction;

c) calculating the required positions, orientations, and drive settings of the at least one acting tug using an algorithm that accesses the data model and generating control commands for the at least one tug such that the sum of all the force vectors and torques of the at least one acting tug corresponds to the required correction force vector and correction torque;

d) transmitting the generated control commands to at least one acting tug and monitoring the completion of the control commands;

e) conducting an evaluation of the produced correction force vector and correction torque after completion of the control commands and generating and storing correction values in the data model when deviations are detected between the produced correction force vector and the required correction force vector and/or between the produced correction torque and the required correction torque and then repeating steps c) to e).

According to this invention, this achieves a self-learning and continuously optimizing assistance system, which determines the optimal position and orientation of the individual tugs relative to the ship and converts these into control commands for the individual propulsion systems in order to exert the desired force on the ship to be assisted. In this case, the assistance system is continuously trained and optimized through constant optimization of the data model during the running of the maneuver.

The initially stored data of the provided data model, which is accessed by the algorithm for calculating the required positions, orientations, and drive settings of the at least one acting tug, can be generated and provided by the initial running of specified maneuvers.

In order to embody the correction complexity and optimization routine in an efficient way, according to one embodiment of this invention, limit values are specified and in step e), the generating and storing of correction values in the data model are carried out upon detection of deviations of the produced correction force vector from the required correction force vector and/or deviations of the produced correction torque from the required correction torque that exceed the limit value and when the limit values are not exceeded, no correction values are generated and stored. The limit values can be input into the system or can be read out from a database and thus serve as a discontinuation criterion for the continuous optimization of the self-learning system.

The fixed data included in the data model can include at least one element of the group comprising the hull shape, the main dimensions, the relative height of a tow line connection, the characteristics of the skeg, the position of the propulsion systems, the type and performance of the propulsion systems of the ship and/or at least one tug.

The variable environmental data included in the data model can include at least one element of the group comprising the length of the tow line and its spatial position, the current travel speed and travel direction, the water depth, and the wind and/or wave load of the ship and/or at least one tug.

While the fixed data are known in advance and can be entered manually or automatically read from a corresponding database, the variable environmental data are preferably detected by suitable sensors on board the ship and/or on board at least one or all of the acting tugs and are stored in the data model continuously or at predetermined time intervals.

In the context of this invention, it is not necessary for all of the above-mentioned fixed and/or variable data to be present, but by taking into account the greatest possible quantity of data, the precision of the method according to this invention and the required training duration before the achievement of optimal solutions is significantly reduced.

At the beginning of the access to the data model, the method according to this invention will, based on the influence variables, already calculate the required magnitude of the steering forces of the individual tugs and the direction of the propulsion systems used, but cannot yet immediately arrive at the desired or optimal results since the data model does not know the ship form, its configuration, and the resulting properties of the ship. Through a fixed pattern of a fixed number of maneuvers, the forces exerted on the tow line are determined and are stored and processed in a computer of a data processing system that implements the method according to the invention. For example, this process can be carried out on a ship that is to be escorted or on another tug during the first test trip. But the algorithm gradually adapts the data model to the specific circumstances of the individual tug and continuously determines better solutions during operation.

The control commands generated using the method according to this invention can comprise the angle between the ship and tug, the angle between the ship and tow line, that heading of the tug, and the rudder angle and/or thrust of the propulsion systems of the tug. According to this invention, the rudder angle here is understood, depending on the design of the propulsion systems, as both a specific angular position of a rudder system and the angular position of a rudder propeller that pivots around the vertical axis or of a Voith-Schneider propeller with a controllable thrust direction.

The control commands that are generated and then transmitted to the at least one tug can either be merely displayed in the respective tug in order to serve as an aid to the captain who still controls the tug himself or in the respective tug, can be read as default values into a dynamic positioning system of the at least one tug so that the tug implements the control commands in a fully automated way. In this case, all that is needed is for the captain of the tug to monitor the process or else the tug is operated in an entirely unmanned fashion.

According to another embodiment of this invention, the variable data can also comprise limitations of the surrounding body of water from an electronic nautical chart, for example limitations due to the water depth, width of the passage, obstacles, speed limits, and also traffic conditions of the surrounding shipping traffic, which are taken into account by the algorithm in the generation of the control commands.

In addition, the data model can also comprise data about the permissible operating conditions of the at least one tug so that dangerous operating conditions for the individual tugs are automatically avoided. For example, the affronting of the tug that occurs with the thrust, the cable forces, and external environmental loads can, when specified limits are exceeded, result in a capsizing of the tug. Because of the self-learning properties of the method according to this invention, each maneuver of the towing train is executed in the best possible way using the permissible ranges of the individual tugs.

The continuous updating of the data model also with regard to the variable environmental data that are taken into account also makes it possible to automatically correct for failures; for example, if a tow line on a tug breaks, the required correction force vector can be produced by repositioning the remaining tugs.

### BRIEF DESCRIPTION OF THE DRAWINGS

The method according to this invention is explained in greater detail below in view of the drawings, wherein:

FIG. 1 schematically shows the acting forces and factors of a typical arrangement of a tug operating in an escort mode behind a ship to be assisted; and

FIG. 2 shows the forces and moments occurring in a towing train through the use of the method according to this invention.

### DETAILED DESCRIPTION OF INVENTION

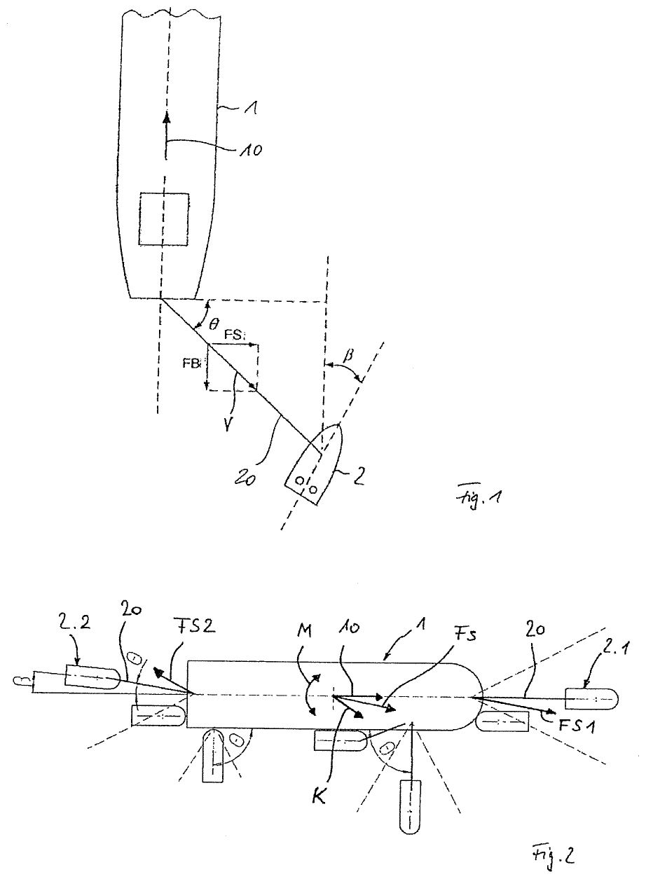

FIG. 1 shows the typical arrangement of a tug 2 operating in escort mode for a towing train, positioned behind a ship 1 to be assisted, which generates a propulsion vector 10 by its own propulsion or by another tug traveling ahead of it, not shown here. At the stern of the ship 1, the tug 2 is connected to the ship 1 by a tow line 20 and has the task of generating braking forces FB and steering forces FS. The force V in the tow line 20 is the result of all of the forces acting on the tug 2 as a result of the propulsion, the flow forces on the hull of the ship 1 and the hull of the tug 2, and any wind and wave loads. The angle between the ship 1 and the tow line 20 is referred to as θ and the angle between the longitudinal axis f of the tug 2 and the ship 1 is referred to as β.

FIG. 2 shows a schematic top view of a towing train comprising the ship 1 and a first tug 2.1 traveling ahead of it, which is connected to the bow of the ship 1 by a tow line 20, as well as a second tug 2.2, which is connected to the stern of the ship 1 by another tow line 20. Furthermore, possible positions of the tugs or of additional tugs relative to the ship 1 are also shown.

In a data processing system installed, for example, in a control room on board one of the tugs 2.1, 2.2 or in a remotely positioned control room, for example, on land, a data model that includes fixed data of the ship 1 and the tugs 2.1, 2.2 is stored in a corresponding memory. In this case, these data can involve the hull shape, the main dimensions such as the length, width, draft, and trim, as well as hydrostatic data about the ship 1 and the tugs 2.1, 2.2, which data are respectively present on board and are correspondingly stored manually or automatically or can be interpreted with regard to the respective current draft. The fixed data also include the relative height of the tow line connection of the individual tow line 20, the characteristics of the skeg, the position and type of propulsion systems and their performance data for both the ship and of the involved tugs 2.1, 2.2.

The data model also includes variable environmental data such as the length and spatial position of the tow line 20, which are either entered manually or are automatically detected by corresponding sensors, the speed and direction of the ship 1 and tugs 2.1, 2.2, which are read from the respective electronic chart display and information system (ECDIS), the water depth, which is likewise determined from the ECDIS or detected by onboard sensors, and environmental conditions such as wind and wave loads, which are detected by onboard sensors.

For a desired maneuvering task, the ship 1 can be moved in a desired travel direction Fs by the tugs 2.1, 2.2, which makes it necessary, depending on the circumstances explained based on FIG. 1, to pilot the tugs 2.1, 2.2 with the associated tow lines 20 to a particular optimal position and to operate with an optimal adjustment of the propulsion systems with regard to the produced thrust and direction. In this case, the tug 2.1 generates the force vector FS1 and the tug 2.2 generates the force vector FS2, which in the ideal case, add up to a resulting correction force vector K and a corresponding correction torque, which exactly produce the desired travel direction Fs of the ship. The difficulty lies in positioning the tugs 2.1, 2.2 so that the exactly required force vectors FS1, FS2 are produced, which requires precise knowledge of the conditions and a large amount of experience on the part of the involved skippers.

In an automated assistance system according to this invention, with a feedback of the thrust vector and/or the inertial force in the direction of the ship and the course of the latter, the data processing system determines the resulting correction force vector K and the correction torque required to achieve the specified desired travel direction FS of the ship.

An algorithm running on the data processing system balances the determined correction force vector K and the correction torque with the possible positions and orientations of the involved tugs 2.1, 2.2 shown in FIG. 2 and calculates the required positions, orientations, and drive settings of the acting tugs 2.1, 2.2 drawing on the data stored in the data model and generates corresponding control commands for the tugs 2.1, 2.2, which comprise the angle θ between the ship 1 and tow line 20, the angle β between the ship 1 and the tug 2.1 and 2.2, respectively, the heading of the tug 2.1, 2.2, the propulsion system/rudder angle, and the performance or speed and thrust of the individual tug 2.1, 2.2.

These generated control commands are transmitted to the acting tugs 2.1, 2.2 and are either merely displayed in the respective bridge in order to assist the captain in executing the required maneuver or are immediately converted into commands for a dynamic positioning system of the tugs 2.1, 2.2 so that the tugs 2.1, 2.2 automatically start the control commands. The accomplishment of the calculated control commands is monitored and is likewise fed back to the data processing system.

As soon as the calculated control commands of the tugs 2.1, 2.2 have been accomplished or executed, an evaluation of the actually produced correction force vector and correction torque is carried out and when deviations from the required correction force vector K and/or required correction torque are detected, corresponding correction values are stored in the data model so that the control commands can then be recalculated and transmitted to the tugs 2.1, 2.2 with the next evaluation so that the data model is continuously optimized.

As a result, according to the “machine learning” principle, a continuously optimizing data model of the towing train is obtained, which in a short time, as a default assistance value, determines or automatically sets the best position, orientation, and power output of the tugs 2.1, 2.2 in order to achieve the greatest possible effect with optimal efficiency.

In this connection, local circumstances of the channel, the prevailing traffic conditions, and dangerous operating conditions can be taken into account and failures can be automatically corrected.

The cable force specified by the system can be maintained statically or can also be intermittently increased through dynamic navigation.

Naturally, instead of the above-explained exemplary embodiment with two tugs 2.1, 2.2, it is also possible to calculate and control towing trains with only one tug or with more than two such tugs.

In any case, the involved tugs are utilized with optimal efficiency in the respective towing maneuver so that the duration of the towing maneuver and the fuel consumption required to execute it are minimized.

In summary, the method according to this invention forms the basis of an assistance system for the positioning and control of tugs in which the data basis for describing the individual capacity of the tug is generated by a continuous learning process and is continuously improved and the determination of the optimal position for assisting a ship can be carried out preferably operating in an escort mode, but also in other possible tug positions. An automatic starting of the position of the tugs and adjustment of the orientation of the ship are just as achievable as an automatic holding of the positions and automatic control of the generated pulling and pushing forces on the ship. Impermissible operating ranges, such as directions of the thrust jet for preventing harmful interactions between the thrust jet and the ship, as well as limitations within the channel and dangerous operating states, which can involve the danger of a tug capsizing, are reliably avoided. In addition to the use as a stand-alone system for an individual tug, it is also possible for a coordination of a plurality of tugs in the towing train to be carried out. Furthermore, in an enhanced upgrade level of the basic software, it is also possible to simulate corresponding assistance maneuvers.

1. A method for controlling a towing train including a ship (1) and at least one tug (2, 2.1, 2.2) acting on the ship (1), comprising the steps of:
a) providing a data model, which comprises fixed data of the ship (1) and of the at least one tug (2, 2.1, 2.2) and variable environmental data;
b) determining the current course, the thrust vector (10), and the inertial force of the ship (1) and specifying a desired travel direction (Fs) of the ship (1) with a subsequent calculation of the correction force vector (K) and a correction torque (M) required to achieve the desired travel direction (Fs);
c) calculating the required positions, orientations, and drive settings of the at least one acting tug (2, 2.1, 2.2) using an algorithm that accesses the data model and generating control commands for the at least one tug (2, 2.1, 2.2) such that the sum of all the force vectors (FS1, FS2), and torques of the at least one acting tug (2, 2.1, 2.2) corresponds to the required correction force vector (K) and correction torque (M);
d) transmitting the generated control commands to at least one acting tug (2, 2.1, 2.2) and monitoring the completion of the control commands;
e) conducting an evaluation of the produced correction force vector and correction torque after completion of the control commands and generating and storing correction values in a data model when deviations are detected between the produced correction force vector (K′) and the required correction force vector (K) and/or between the produced correction torque (M′) and the required correction torque (M) and then repeating steps c) to e).

2. The method according to claim 1, wherein values are specified and in step e), the generating and storing of correction values in the data model are carried out upon detection of deviations of the produced correction force vector (K′) from the required correction force vector (K) and/or deviations of the produced correction torque (M′) from the required correction torque (M) that exceed the limit value and when the limit values are not exceeded, no correction values are generated and stored.

3. The method according to claim 2, wherein the fixed data in the data model include at least one of the following: a hull shape, main dimensions, a relative height of a tow line connection, characteristics of the skeg, a position of the propulsion systems, a type of propulsion systems, and a performance data of the propulsion systems of the ship (1) and/or at least one tug (2, 2.1, 2.2).

4. The method according to claim 3, wherein the variable data in the data model include at least one of the following: a length of the tow line (20) and a spatial position, a current travel speed and travel direction, a water depth, and a wind and/or wave load of the ship (1) and/or at least one tug (2, 2.1, 2.2).

5. The method according to claim 4, wherein the control commands comprise an angle (β) between the ship (1) and the at least one tug (2, 2.1, 2.2), an angle (σ) between the ship (1) and tow line (20), a heading of the at least one tug (2, 2.1, 2.2), and a rudder angle and/or thrust of the propulsion systems of the at least one tug (2, 2.1, 2.2).

6. The method according to claim 5, wherein the transmitted control commands are displayed in the at least one tug (2, 2.1, 2.2) and/or are read as default values into a dynamic positioning system of the at least one tug (2, 2.1, 2.2).

7. The method according claim 6, wherein the variable data also comprise limitations of a surrounding body of water from an electronic nautical chart as well as surrounding shipping traffic and are taken into account by the algorithm in a generation of the control commands.

8. The method according to claim 7, wherein the data model also comprises data about the permissible operating conditions of the at least one tug (2, 2.1, 2.2).

9. The method according to claim 1, wherein the fixed data in the data model include at least one of the following: a hull shape, main dimensions, a relative height of a tow line connection, characteristics of the skeg, a position of the propulsion systems, a type of propulsion systems, and a performance data of the propulsion systems of the ship (1) and/or at least one tug (2, 2.1, 2.2).

10. The method according to one of claim 1, wherein the variable data in the data model include at least one of the following: a length of the tow line (20) and a spatial position, a current travel speed and travel direction, a water depth, and a wind and/or wave load of the ship (1) and/or at least one tug (2, 2.1, 2.2).

11. The method according to claim 1, wherein the control commands comprise an angle (β) between the ship (1) and the at least one tug (2, 2.1 2.2), an angle (σ) between the ship (1) and tow line (20), a heading of the at least one tug (2, 2.1, 2.2), and a rudder angle and/or thrust of the propulsion systems of the at least one tug (2, 2.1, 2.2).

12. The method according to claim 1, wherein the transmitted control commands are displayed in the at least one tug (2, 2.1, 2.2) and/or are read as default values into a dynamic positioning system of the at least one tug (2, 2.1, 2.2).

13. The method according claim 1, wherein the variable data also comprise limitations of a surrounding body of water from an electronic nautical chart as well as surrounding shipping traffic and are taken into account by the algorithm in a generation of the control commands.

14. The method according to claim 1, wherein the data model also comprises data about the permissible operating conditions of the at least one tug (2, 2.1, 2.2).
